(19) United States
(12) Patent Application Publication
(10) Pub. No.: US 2025/0385709 A1
(43) Pub. Date: Dec. 18, 2025

(54) DIGITAL LEAKAGE CANCELING DEVICE OF RFID READER AND METHOD THEREOF

(71) Applicant: Phychips Inc., Daejeon (KR)

(72) Inventors: Jinho Ko, Daejeon (KR); Jae Heon Lee, Daejeon (KR)

(73) Assignee: Phychips Inc., Daejeon (KR)

(21) Appl. No.: 18/744,599

(22) Filed: Jun. 15, 2024

(51) Int. Cl. H04B 1/525; G06K 7/00

(52) U.S. Cl. CPC H04B 1/525; G06K 7/0008

(57) ABSTRACT

The present invention discloses a digital leakage canceling device of an RFID reader and a method thereof. The device includes: a coupling unit configured to couple an antenna signal and a power amplifier signal; an RF/Analog transceiving unit configured to convert a transmission leakage signal generated in the coupling unit into a baseband IQ signal and generate a transmission leakage removal signal as an IQ code to cancel the transmission leakage; a leakage cancellation controller configured to receive the converted baseband IQ signal, calculate a magnitude and a phase of the signal, and output a leakage cancellation control signal; and an attenuation and amplification unit configured to attenuate a magnitude of the coupled signal, amplify an RF transmission signal output from the RF/Analog transceiving unit using a built-in power amplifier, and transmit the amplified signal to the coupling unit.

### BACKGROUND

The present disclosure relates to an RFID reader, and more particularly, to a digital leakage canceling device of an RFID reader, which is capable of canceling a leakage signal generated from the RFID reader in a digital manner and a method thereof.

A radio frequency identification (RFID) system is a typical example of a communication system having the same frequency of a transmission signal and a reception signal.

The RFID represents a technology of automatically recognizing data stored in a tag, a label, and a card, which contain a micro-chip by a reader using a radio frequency.

The RFID system recognizes identification information of an object and surrounding environment information by attaching a tag to an object to be managed such as a product and using a radio wave to collect, store, process, and chase information of each object, thereby providing various services such as positioning, remote processing, and management of an object and information exchange between objects.

The RFID has an advantage of being able to simultaneously recognize a plurality of tags in a non-contact manner, have a short recognition time, store a large amount of data in the tags, and be used semi-permanently.

Thus, the RFID is expected as a next-generation core technology that compensates a weakness of a typical barcode or magnetic recognition device and improve user convenience.

The RFID system includes a tag, a reader, and a server (middleware and application service platform) and is connected to a wired and wireless communication network.

The tag having information that is able to recognize an object is disposed on the object, and the reader has a communication function for collecting and processing the information of the object and transmit the information to a server. The server performs application processing by using the information of the object.

The RFID reader performs a function of transmitting power and a command for operating a passive tag as a wireless carrier signal to the tag and receiving a response from the tag to restore the signal.

The RFID reader system includes an RF analog unit and a digital signal processing control unit.

The RF analog unit includes a transmitting unit including a power amplifier and a frequency up mixer for transmitting power and data to an antenna and a receiving unit including a low noise amplifier and an analog signal processing unit for restoring a response signal received from the RFID tag to the antenna.

The digital signal processing control unit includes a decoder, an encoder, a clock generation circuit, a memory, a processor, and a host interface part.

The transmitting unit and receiving unit of the RFID reader transmit/receive a signal through one antenna and are connected to the antenna through a circulator or a coupler.

The circulator and the coupler allow the antenna to be connected to one of the transmitting unit and the receiving unit according to a transmitting and receiving timing and to be isolated from the other so that the signal is not transmitted.

FIG. 1 is a block diagram illustrating an RF analog front end of a typical RFID receiver. FIG. 2 is an internal block diagram of a self-jamming cancellation unit in the typical general RFID receiver illustrated in FIG. 1.

As illustrated in FIG. 1, the self-jamming cancellation unit is disposed between a power amplifier (PA) 610, a circulator 612, and a low noise amplifier (LNA) 607 to remove a self-jamming signal reflected from the antenna and applied to a RX_IN node through the circulator 612.

Also, as illustrated in FIG. 2, the self-jamming cancellation unit includes a phase variant generation circuit 710, a phase variant selection circuit 720, and an amplitude adjustment summation circuit 730.

The phase variant generation circuit 710 receives a transmission signal TX_SIG to generate and output a multi-phase change (e.g.: 30° or) 45°, and the phase variant selection circuit 720 selects phase A and phase B among a plurality of phases generated from the phase variant generation circuit 710.

The amplitude adjustment summation circuit 730 minimizes a magnitude of a self-jamming output signal SJC_OUT by changing a value of a capacitor in a circuit using an amplitude control signal AMP_ADJ and controlling the amplitude.

An input signal FB_IN of FIG. 2 substantially corresponds to a mixer output signal MIX_OUT of FIG. 3, and the self-jamming cancellation unit eventually operates to minimize a direct current DC of the mixer output signal MIX_OUT.

The phase A and the phase B are selected by sub-orthogonal coordinates to reduce a current consumption of the amplitude adjustment summation circuit 730.

However, the typical general RFID receiver removes the self-jamming signal input to the amplitude adjustment summation circuit 730 through an RX_IN input port by using a coarse phase selection process of selecting two adjacent phase variants of phase variants of the transmission signal generated through the phase variant generation circuit 710 and a fine tuning process of adjusting a capacitor through the amplitude control signal AMP_ADJ.

As described above, the typical general RFID receiver consumes much time to remove the self-jamming output signal SJC_OUT through the two processes of the coarse phase selection process and the fine tuning process.

Also, since phase control and magnitude control are separated, two nonlinear operations are required.

However, when these series of processes are realized as a circuit, there is a limitation of realizing the processes with digital hardware.

Also, since an intensity of the transmission signal is extremely greater than that of the reception signal, the transmission signal may be leaked to the receiving unit instead of being completely blocked by the circulator or coupler, which causes a limitation of degradation in quality of the reception signal of the RFID reader system.

Also, an operation of leakage cancellation of the transmission signal is frequently performed to solve the above-described limitation. While the RFID reader reads the tag, a leakage phenomenon of the transmission signal continuously changes due to changes in transmission output power or surrounding environment of the antenna. As a result, a time for leakage cancellation of the transmission signal affects a time for reading the tag.

Also, since the RFID tag that is a passive element has a structure of operating by receiving energy from the reader, a larger transmission output is required to be emitted in order to receive a signal of the tag disposed at a distance. Here, there is a limitation in that, as the transmission output increases, an intensity of the leakage signal applied to the RFID receiver also increases.

### PRIOR ART DOCUMENTS

### Patent Documents

(Patent Document 1) U.S. Pat. No. 8,260,241 B1

### SUMMARY

The present invention provides a digital leakage canceling device of an RFID reader, which is capable of increasing an RFID recognition distance by quickly and effectively removing a self-jamming using a digital leakage cancellation method in the RFID reader in an UHF frequency band.

The present invention also provides a digital leakage cancellation method of an RFID reader.

An embodiment of the present invention provides a digital leakage canceling device of an RFID reader, including: a coupling unit configured to couple an antenna signal and a power amplifier signal; an RF/Analog transceiving unit configured to convert a transmission leakage signal generated in the coupling unit into a baseband IQ signal and generate a transmission leakage removal signal as an IQ code to cancel the transmission leakage; a leakage cancellation controller configured to receive the converted baseband IQ signal, calculate a magnitude and a phase of the signal, and output a leakage cancellation control signal; and an attenuation and amplification unit configured to attenuate a magnitude of the coupled signal, amplify an RF transmission signal output from the RF/Analog transceiving unit using a built-in power amplifier, and transmit the amplified signal to the coupling unit. Here, the transmission leakage signal and the transmission leakage removal signal are summed and canceled in the coupling unit.

In an embodiment, the coupling unit may include: a first coupler having one side connected to the antenna and the other side connected to an output terminal of the attenuation and amplification unit to perform a first coupling with a signal of an input terminal of the attenuation and amplification unit; and a second coupler having one side connected to an intersection with the first coupler and the other side connected to an output terminal of the RF/Analog transceiving unit to perform a second coupling, thereby outputting a sum of both signals.

In an embodiment, the RF/Analog transceiving unit may include: a receiving unit mixer configured to receive an RF signal from a node that is second-coupled and multiply the received signal by a local oscillator signal to down-convert the multiplied signal into a baseband signal; a digital signal generation unit configured to receive the down-converted baseband signal through first and second paths and convert the received signal into a digital signal; a leakage cancellation amplification unit configured to receive the attenuated coupling signal and adjust a phase and an amplitude of the received signal in response to the leakage cancellation control signal to output the adjusted signal to an output terminal of the RF/Analog transceiving unit; and an RF analog signal processing unit configured to restore a response signal received from an RFID tag to the antenna.

In an embodiment, the digital signal generation unit may include: a receiving unit baseband analog unit configured to receive the down-converted baseband signal through the first and second paths to amplify the received signal to a predetermined magnitude or remove components except for the signal; a receiving unit AD converter configured to receive the baseband signal which is amplified or from which components except for the signal is removed through the first and second paths and convert the received signal into a digital signal; a receiving unit continuous feedback amplifier configured to receive the down-converted baseband signal through the first and second paths to frequency-down-convert a transmitting unit leakage signal and amplify an analog signal; and a general-purpose ADC configured to receive the amplified analog signal and convert the received signal into a digital signal, thereby outputting an IQ signal LEAK_I and LEAK_Q of the leakage signal.

In an embodiment, the attenuation and amplification unit may include: an attenuator configured to receive the signal coupled in the first coupler and attenuate a magnitude of the signal to be fit into an input range of the leakage cancellation amplification unit 300, thereby transmitting the attenuated signal to an input terminal (LCAIN) of the RF/Analog transceiving unit; and a power amplifier configured to receive the restored response signal from the RF analog signal processing unit and amplify power thereof to outputs the amplified signal to the other end of the first coupler.

In an embodiment, the leakage cancellation amplification unit may include: an IQ signal generator configured to receive the attenuated signal from the attenuator and convert the received signal into a pair of I differential signals I+ and I− and a pair of Q differential signals Q+ and Q− to output the converted signals; and a dual leakage cancellation amplifier configured to receive the pair of converted I differential signals I+ and I− and the pair of converted Q differential signals Q+ and Q− and adjust phases and an amplitudes of the received signal in response to an I control signal LC_CTRL_I and a Q control signal LC_CTRL_Q to output the adjusted signals to the second coupler.

In an embodiment, a signal at an output node C of the dual leakage cancellation amplifier may be coupled with a signal at a node D, which is obtained as an input signal is self-jammed in the first coupler, in the second coupler and applied to a receiving input node of the RF/Analog transceiving unit.

In an embodiment, the dual leakage cancellation amplifier may generate a signal having a magnitude and a phase sufficient to remove transmission leakage at the node D and supply the signal to the node C that is the other side of the second coupler.

In an embodiment, the dual leakage cancellation amplifier may include: a plurality of I control leakage cancellation amplifiers LCA_I configured to receive a pair of I differential signals I+ and I− from the IQ signal generator and output a plurality of pairs of first output signals OUT1+ and OUT1− in response to a plurality of pairs of I control signals CTRL_I+ and CTRL_I−; a plurality of Q control leakage cancellation amplifiers LCA_Q configured to receive a pair of Q differential signals Q+ and Q− from the IQ signal generator and output a plurality of pairs of second output signals OUT2+ and OUT2− in response to a plurality of pairs of Q control signals CTRL_Q+ and CTRL_Q−; an I control decoder configured to receive and decode an I control signal having a plurality of bits from the leakage cancellation controller to output the plurality of pairs of I control signals CTRL_I+ and CTRL_I−; a Q control decoder configured to receive and decode a Q control signal having a plurality of bits from the leakage cancellation controller to output the plurality of pairs of Q control signals CTRL_Q+ and CTRL_Q−; and a balance to unbalance transformer configured to receive a plurality of pairs of first output signals OUT1+ and OUT1− and a plurality of pairs of second output signals OUT2+ and OUT2− to match the received signals and output one output signal OUT.

In an embodiment of the present invention, a digital leakage cancellation method of an RFID reader includes: (a) initializing an IQ control signal of a leakage cancellation amplifier when transmission power is turned on; (b) receiving a digital IQ signal LEAK_I and LEAK_Q and calculating a magnitude and a phase of the signal by a leakage cancellation controller; (c) comparing a magnitude value of the calculated signal with a preset minimum value by the leakage cancellation controller; (d) setting an I control signal LC_CTRL_I and a Q control signal LC_CTRL_Q as final values when the magnitude value of the calculated signal is equal to or less than the preset minimum value; (e) modifying the IQ control signal by the leakage cancellation controller so that the digital IQ signal LEAK_I and LEAK_Q of the leakage signal has a minimum magnitude value when the magnitude value of the calculated signal is greater than the preset minimum value; (f) changing an output signal at an output terminal LCAOUT of the RF/Analog transceiving unit and a magnitude and a phase of a signal at an input terminal LCAIN of the RF/Analog transceiving unit when the modified value is applied to the leakage cancellation amplifier; and (g) repeating the processes (b) to (f) until a magnitude value of the changed signal is equal to or less than the preset minimum value.

In an embodiment, the digital leakage canceling method may further include: between the processes (a) and (b), inputting a signal at an output terminal of a first coupler to the leakage cancellation amplifier; outputting an output signal of the leakage cancellation amplifier to one side of a second coupler in response to control of the IQ control signal by the leakage cancellation amplifier; applying a signal obtained by summing a signal at an intersection between the first coupler and the second coupler and a signal at the other side of the second coupler to an input terminal RX_IN of the RF/Analog transceiving unit; and down-converting the applied and summed signal by a receiving unit mixer and amplifying the down-converted signal using a preset gain by a receiving unit continuous feedback amplifier.

In an embodiment, the digital leakage canceling method may further include: between the processes (a) and (b), inputting a signal at an output terminal of a first coupler to the leakage cancellation amplifier; outputting an output signal of the leakage cancellation amplifier to one side of a second coupler in response to control of the IQ control signal by the leakage cancellation amplifier; applying a signal obtained by summing a signal at an intersection between the first coupler and the second coupler and a signal at the other side of the second coupler to an input terminal RX_IN of the RF/Analog transceiving unit; and down-converting the applied and summed signal by a receiving unit mixer and amplifying the down-converted signal using a preset gain by a receiving unit continuous feedback amplifier.

In an embodiment of the present invention, information on a digital leakage canceling method of an RFID reader according to the present invention is stored in a computer-readable recording medium.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram illustrating an RF analog front end of a typical RFID receiver;

FIG. 2 is an internal block diagram of a self-jamming cancellation unit in the typical general RFID receiver illustrated in FIG. 1;

FIG. 3 is a block diagram of a digital leakage canceling device of an RFID reader according to an embodiment of the present invention;

FIG. 4 is a schematic block diagram for explaining an operation of a first leakage cancellation amplifier of dual leakage cancellation amplifiers in the digital leakage canceling device illustrated in FIG. 3;

FIG. 5 is a schematic block diagram for explaining an operation of a second leakage cancellation amplifier of the dual leakage cancellation amplifiers in the digital leakage canceling device illustrated in FIG. 3;

FIG. 6 is a block diagram illustrating an input and output interface of the dual leakage cancellation amplifiers LCA1 and LCA2 illustrated in FIGS. 4 and 5;

FIG. 7A is an internal circuit diagram of an I path leakage cancellation amplifier in the dual leakage cancellation amplifiers illustrated in FIG. 6;

FIG. 7B is an internal circuit diagram of a Q path leakage cancellation amplifier in the dual leakage cancellation amplifiers illustrated in FIG. 6;

FIGS. 8A and 8B are flowcharts representing a method for canceling a leakage signal according to another embodiment of the present invention; and

FIG. 9 is a view illustrating a waveform at each node as a result of canceling the leakage signal according to the flowcharts in FIGS. 8A and 8B.

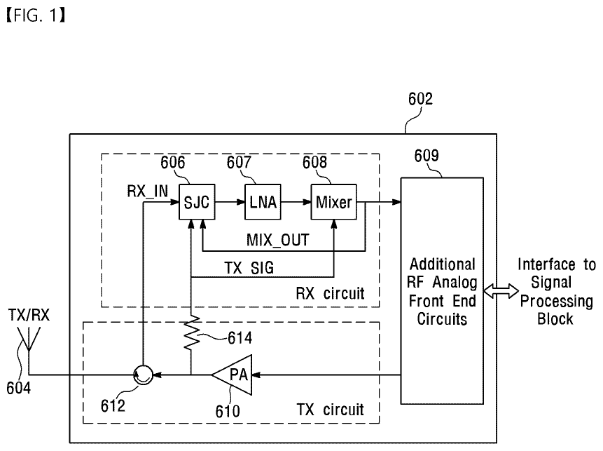

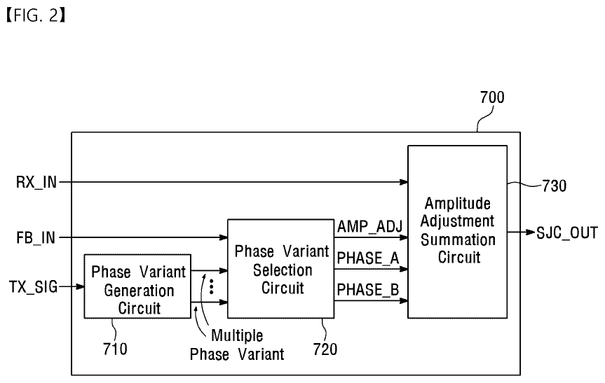

### DETAILED DESCRIPTION

Hereinafter, embodiments disclosed in this specification is described with reference to the accompanying drawings, and the same or corresponding components are given with the same drawing number regardless of reference number, and their duplicated description will be omitted. Furthermore, terms, such as a “module” ad a “unit”, are used for convenience of description, and they do not have different meanings or functions in themselves.

Moreover, detailed descriptions related to well-known functions or configurations will be ruled out in order not to unnecessarily obscure subject matters of the present disclosure. However, this does not limit the present disclosure within specific embodiments and it should be understood that the present disclosure covers all the modifications, equivalents, and replacements within the idea and technical scope of the present disclosure.

Hereinafter, embodiments of the present invention will be described in detail with reference to the accompanying drawings.

RFID uses different frequency bands depending on application fields. Specifically, since the RFID using an UHF band of 860 MHz to 960 MHz has many advantages such as a long recognition distance, a small size of a tag, fast data transmission, and a large data volume over RFID systems having other frequency bands, the RFID is currently applied to a logistics and distribution industry in many countries.

The UHF RFID system is widely applied together with the passive tag that does not include a battery and is referred to as a passive RFID system. A reader of the passive RFID system has a characteristic of always transmitting a continuous wave signal to the tag for power of the tag except a period during which the reader transmits data.

Also, a high isolation characteristic is required in an entire band of 100 MHz for the RFID having the UHF band RFID for flexible use. For the above-described reader system, the high isolation characteristic is required between the transmitting unit and the receiving unit. In a reader system having an incomplete isolation characteristic, a portion of the reception signal is leaked to the transmitting unit to cause degradation of the receiver.

Since many typical RF front-ends suggested to solve the leakage signal limitation have extremely complex structures and sizes or a tag signal loss, an RF front-end having a simple structure, a small size, and a high isolation characteristic is required.

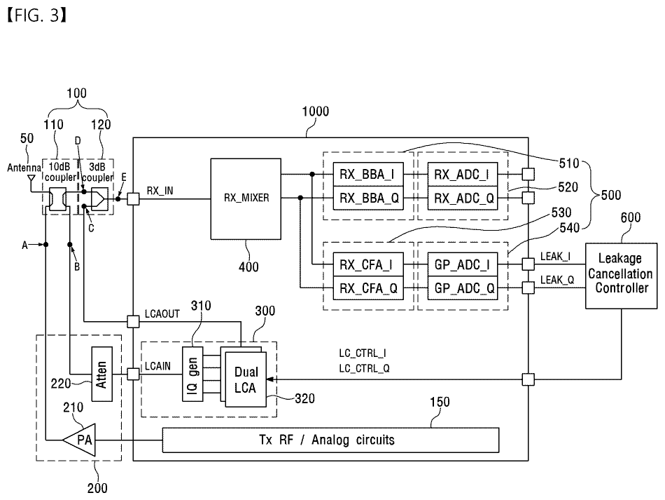

FIG. 3 is a block diagram of a digital leakage canceling device of the RFID reader according to an embodiment of the present invention. The digital leakage canceling device includes a coupling unit 100, an attenuation and amplification unit 200, an RF/Analog transceiving unit 1000, and a leakage cancellation controller 600.

The coupling unit 100 includes a first coupler 110 and a second coupler 120, and the attenuation and amplification unit 200 includes an attenuator 220 and a power amplifier 210.

The RF/Analog transceiving unit 1000 includes a leakage cancellation amplification unit 300, a receiving unit mixer 400, a digital signal generation unit 500, and an RF analog transmission signal processer 150.

The leakage cancellation amplification unit 300 includes an IQ signal generator 310 and a dual leakage cancellation amplifier 320, and the digital signal generation unit 500 includes a baseband analog unit 510, a receiving unit AD converter 520, a receiving unit continuous feedback amplifier 530, and a general-purpose ADC 540.

Hereinafter, a structure and a function of each of components of the digital leakage canceling device of the RFID reader according to an embodiment of the present invention will be described in brief with reference to FIG. 3.

The coupling unit 100 couples a signal of an antenna 50 and a signal of the power amplifier 210.

That is, the first coupler 110 has one side connected to the antenna 50 and the other side connected to an output terminal of the attenuation and amplification unit 200 to perform a first coupling with a signal of an input terminal of the attenuation and amplification unit 200.

The second coupler 120 has one side connected to an intersection D with the first coupler 110 and the other side connected to an output terminal of the RF/Analog transceiving unit 1000 to perform a second coupling, thereby outputting a sum of both signals.

The attenuation and amplification unit 200 attenuates a magnitude of a signal coupled in the coupling unit 100 and amplifies a RF transmission signal output from the RF/Analog transceiving unit 1000 with the built-in power amplifier 210 to transmit the amplified signal to the coupling unit 100.

That is, the attenuator 220 receives the signal coupled in the first coupler 110 and attenuates the magnitude of the signal to be fit into an input range of the leakage cancellation amplification unit 300, thereby transmitting the signal to an input terminal LCAIN of the RF/Analog transceiving unit 1000.

The power amplifier 210 receives a frequency up transmission signal from the RF analog transmission signal processing unit 150, amplifies power thereof, and outputs the amplified signal to the other end of the first coupler 110.

The RF/Analog transceiving unit 1000 converts a transmission leakage signal generated in the coupling unit 100 into a baseband IQ signal and generates a transmission leakage removal signal as an IQ code to cancel the transmission leakage.

That is, the receiving unit mixer 400 receives a RF signal from a node that is second-coupled in the second coupler 120 and multiplies the received signal by a local oscillator signal to down-convert the multiplied signal into a baseband signal.

The digital signal generation unit 500 receives the baseband signal that is down-converted in the receiving unit mixer 400 through a first path (I path) and a second path (Q path) and converts the received signal into a digital signal.

Here, the I signal represents an in-phase signal that is a real number portion on a complex number plane, and the Q signal represents a quadrature signal that is an imaginary number portion.

In more detail, IQ modulation and demodulation are generally and frequently used in a digital communication system.

The leakage cancellation amplification unit 300 receives a coupling signal attenuated in the attenuator 220 and adjusts a phase and an amplitude of the received signal in response to a leakage cancellation control signal to output the adjusted signal to the output terminal of the RF/Analog transceiving unit 1000.

That is, the IQ signal generator 310 changes the RF signal attenuated in the attenuator 220 into an IQ signal and converts the changed signal into a pair of I differential signals I+ and I− and a pair of Q differential signals Q+ and Q− to output the converted signals.

The dual leakage cancellation amplifier 320 receives the pair of I differential signals I+ and I− and the pair of Q differential signals Q+ and Q− converted in the IQ signal generator 310 and adjusts a phase and an amplitude of the signal in response to an I control signal LC_CTRL_I that is the leakage cancellation digital control signal and a Q control signal LC_CTRL_Q, which are the leakage cancellation digital control signal, to output the adjusted signals to the second coupler 120.

The digital signal generation unit 500 receives the baseband signal that is down-converted in the receiving unit mixer 400 through the first and second paths and converts the received signal into a digital signal.

That is, the baseband analog unit 510 receives the baseband signal that is down-converted in the receiving unit mixer 400 through the first and second paths and amplifies the received signal to a predetermined magnitude or removes components except for the signal.

The receiving unit AD converter 520 receives the baseband signal which is amplified in the baseband analog unit 510 or from which components except for the signal is removed through the first and second paths and converts the received signal into a digital signal.

The receiving unit continuous feedback amplifier 530 receives the baseband signal that is down-converted in the receiving unit mixer 400 through the first and second paths to frequency-down-convert the transmitting unit leakage signal and amplify an analog signal.

The general-purpose ADC 540 receives the analog signal amplified in the receiving unit continuous feedback amplifier 530 and converts the received signal into a digital signal to output the IQ signals LEAK_I and LEAK_Q of the leakage signal.

The RF analog transmission signal processing unit 150 provides a continuous wave (CW) signal for supplying power to the RFID tag or frequency-up-converts a command of the RFID reader, thereby transmitting the converted signal to the power amplifier 210.

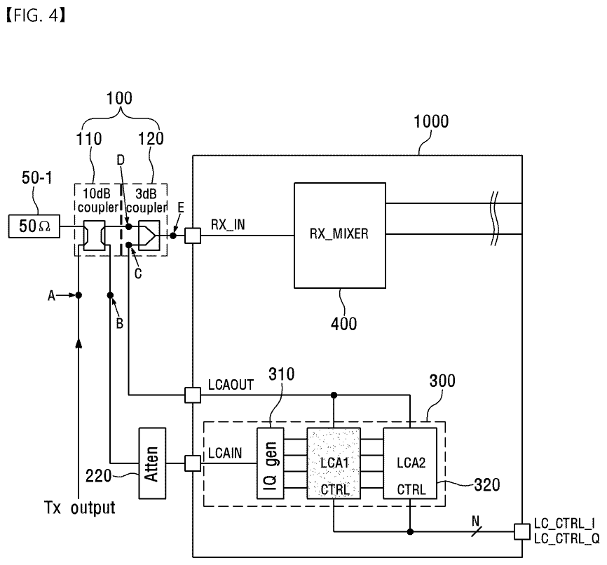

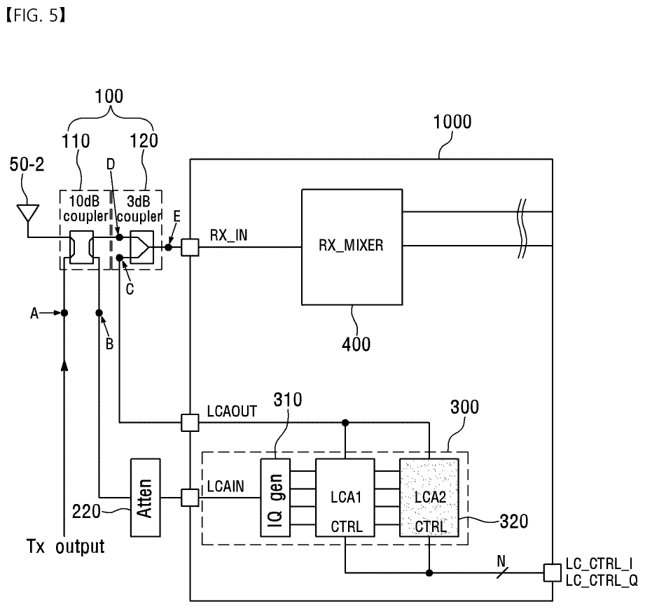

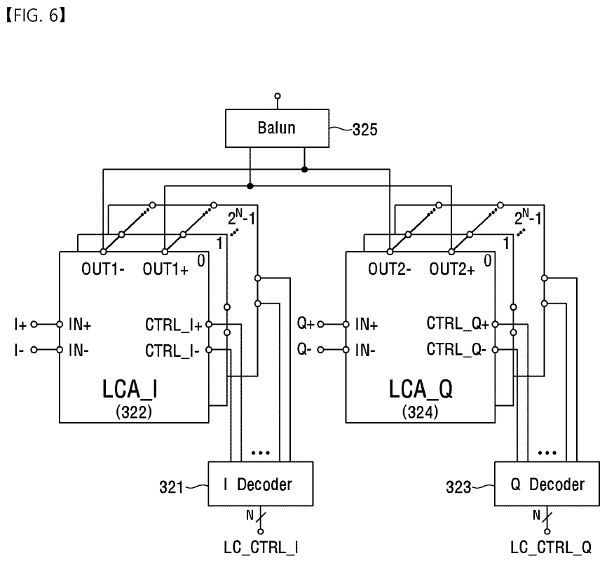

FIG. 4 is a schematic block diagram for explaining an operation of a first leakage cancellation amplifier of the dual leakage cancellation amplifiers 320 in the digital leakage canceling device illustrated in FIG. 3. FIG. 5 is a schematic block diagram for explaining an operation of a second leakage cancellation amplifier of the dual leakage cancellation amplifiers 320 in the digital leakage canceling device illustrated in FIG. 3. FIG. 6 is a block diagram illustrating an input and output interface of the dual leakage cancellation amplifier (LCA1 and LCA2) 320 illustrated in FIGS. 4 and 5.

Hereinafter, an operation of the digital leakage canceling device of the RFID reader according to an embodiment of the present invention will be described in detail with reference to FIGS. 3 to 6.

As illustrated in FIG. 3, a transmission output Tx output (A) of the power amplifier (PA) 210 is transmitted to the antenna 50 through a 10 dB coupler 110, and a reception signal input to the antenna 50 is applied to a reception input nodes (RX_IN) E through a 10 dB coupler 110 and a 3 dB coupler 120.

Here, the 10 dB coupler 110 is a passive element that transmits an output of the transmission power amplifier (PA) 210 to the antenna 50 or transmits a 10 dB coupling signal of the signal received by the antenna 50 to a receiving end, and the 3 dB coupler 120 is a passive element that receives a signal input from a node D and a signal input from a node C and outputs a sum of the two signals.

The receiving unit mixer 400 RX_Mixer receives a RF signal from the 3 dB coupler 120, multiplies the received signal by a local oscillator (LO) signal, and down-converts the multiplied signal to a baseband signal.

Also, the baseband analog unit 510 BBA receives the baseband signal and amplifies the baseband signal to a predetermined magnitude or cancels components except for the signal.

The receiving unit AD converter 520 receives a baseband analog signal from the baseband analog unit 510 and converts the received signal into a digital signal.

Here, an output of the receiving unit mixer 400 is divided into the I differential signal (I signal) and the Q differential signal (Q signal) with a phase difference between the local oscillator signals and generated as first and second mixing output signals, and all of the baseband analog unit 510 and the receiving unit AD converter 520 are divided into the I path and the Q path.

The receiving unit continuous feedback amplifier (RX CFA) 530 receives an output of the receiving unit mixer 400 that is divided and output into the I path and the Q path, frequency-down-converts the receiving unit leakage (Tx leakage), and amplifies the converted signal.

The general-purpose ADC (GP ADC) 540 receives an analog output from the receiving unit continuous feedback amplifier 530 and converts the received signal into a digital signal to output the digital IQ signals LEAK_I and LEAK_Q.

The leakage cancellation controller 600 receives the digital IQ signals LEAK_I and LEAK_Q from the general-purpose ADC 540 and analyzes a phase signals and a magnitude of the transmission leakage Tx to generate the I control signal LC_CTRL_I and the Q control signal LC_CTRL_Q, which have opposite phases.

On the other hand, a transmission output from the node A is coupled through the 10 dB coupler 110 and transmitted to the node B, and is attenuated through the attenuator (Atten) 220 and then applied to the node LCAIN.

Here, the attenuator (Atten) 220 attenuates a magnitude of the signal at the node B to be fit into the input range of the dual leakage cancellation amplifier 320 and transmits the signal to the input terminal LCAIN of the RF/Analog transceiving unit 1000.

The IQ signal generator 310 (IQ generator) receives the signal attenuated in the attenuator (Atten) 220 and converts the received signal into a pair of I differential signals I+ and I− and a pair of Q differential signals Q+ and Q− to input the converted signal to the dual leakage cancellation amplifier 320.

The dual leakage cancellation amplifier 320 receives the pair of I differential signals I+ and I− and the pair of Q differential signals Q+ and Q− converted in the IQ signal generator (IQ gen) 310 and adjusts a phase and an amplitude of the received signal in response to the I control signal LC_CTRL_I and the Q control signal LC_CTRL_Q generated in the leakage cancellation controller 600 to output the adjusted signals to an output terminal LCAOUT.

An input signal is applied from the first coupler 110, i.e., 10 dB coupler 110, to the output terminal LCAOUT, i.e., an output node C of the dual leakage cancellation amplifier 320, and a signal that is self-jamming at the node D is coupled in the second coupler 120, i.e., 3 dB coupler, and applied to a receiving input node (RX-IN) E of the RF/Analog transceiving unit 1000.

Here, the 10 dB coupler 110 is used because the transmission signal and the reception signal use the same antenna 50. An output of the power amplifier 210 is applied to the first terminal of the 10 dB coupler 110, and a portion of the signal received from the antenna 50 is coupled through the second terminal.

The transmission leakage (Tx leakage) at the node D consists of a sum of an antenna component reflected by a reflection coefficient S11 characteristic of the antenna 50 when the transmission output is emitted through the antenna 50 and an isolation component transmitted by an isolation characteristic of the 10 dB coupler 110.

Here, the dual leakage canceling amplifier 320 creates a signal having a magnitude and a phase sufficient to eliminate the transmission leakage at the node D and supplies the signal to the node C, thereby minimizing a magnitude of the leakage signal at the node E.

The above-described processes may be repeated to cancel the leakage in the transmitting unit, and the dual leakage cancellation amplifier 320 may perform further precise control by increasing the number of bits of the I control signal LC_CTRL_I and the Q control signal LC_CTRL_Q from the leakage cancellation controller 600 to minimize a magnitude of a signal remained after the cancellation.

As described above, the present invention may: filter the baseband transmission signal, convert the signal as the RF signal by the up conversion mixer, and transmit the converted signal to the power amplifier (PA) 210; convert the measured transmission leakage Tx leakage into the baseband IQ signal; and directly generating the IQ code for producing a signal for removing the transmission leakage Tx leakage through the digital process, to perform control in a linear continuous feedback method, thereby extremely quickly removing the transmission leakage Tx leakage.

Also, additional power consumption that may occur in a summing circuit or heat generation caused by the additional power consumption may be prevented in advance by performing a summing between the leakage signal and the leakage removal signal using the 3 dB coupler 120 that is a passive element.

Next, an operation principle of the dual leakage cancellation amplifier 320 will be described in detail as follows.

A transmission leakage (Tx leakage) at the node D includes a first component caused by isolation of the 10 dB coupler 110 and a second component reflected by a characteristic of a reflection coefficient S11 of the antenna 50.

FIG. 4 is a view for explaining the first component that causes transmission signal leakage at the node D illustrated in FIG. 3.

As illustrated in FIG. 4, when it is assumed that a resistor of 50 ohm that is an equivalent component is connected to a position of the antenna 50 in FIG. 3, a cover range of the dual leakage cancellation amplifier 320 may be adjusted by a current ILCA_CELL flowing per a leakage cancellation amplifier cell.

When the dual leakage cancellation amplifier 320 has N-bit control, a magnitude of maximum leakage that may be canceled is proportional to ILCA_CELL*I path leakage cancellation amplifier LCA_I.

However, as the ILCA_CELL increases, a distance between respective bits on the IQ plane increases, and an amount of cancellation of the maximum leakage decreases.

Here, a first leakage cancellation amplifier LCA1 may secure a leakage cover range by increasing the ILCA_CELL, and the second leakage cancellation amplifier LCA2 may increase the amount of cancellation by decreasing the ILCA_CELL.

When the resistor of 50 ohm is connected to the position of the antenna 50, the transmission leakage (Tx leakage) at the node D is determined by the isolation component of the 10 dB coupler.

The first leakage cancellation amplifier LCA1 serves to remove the leakage generated by the isolation characteristic of the coupler.

FIG. 5 is view for explaining the second component that causes transmission signal leakage at the node D illustrated in FIG. 3.

As illustrated in FIG. 5, when it is assumed that the antenna 50 that is an equivalent component is connected to the position of the resistance of 50 ohm illustrated in FIG. 4, the transmission leakage (Tx leakage) at the node D, which is a component generated by the characteristic of the coefficient S11 of the antenna 50, may be set to be removed by the second leakage cancellation amplifier LCA2.

FIG. 6 is a view for illustrating an input and output interface of the dual leakage cancellation amplifier (LCA1 and LCA2) 320 illustrated in FIGS. 4 and 5.

Since each of the dual leakage cancellation amplifiers (LCA1 and LCA2) 320 illustrated in FIG. 4 and each of the dual leakage cancellation amplifiers (LCA1 and LCA2) 320 illustrated in FIG. 5 have the same configuration, only the first leakage cancellation amplifier LCA1 illustrated in FIG. 4 will be described herein, and this will be applied to the rest leakage cancellation amplifiers.

As illustrated in FIG. 6, the leakage cancellation amplifier LCA1 includes a plurality of I control leakage cancellation amplifiers LCA_I, a plurality of Q control leakage cancellation amplifiers LCA_Q, an I control decoder 321, a Q control decoder 323, and a balance to unbalance transformer (Balun) 325.

The plurality of I control leakage cancellation amplifiers LCA_I receive a pair of I differential signals (I+, I−) from the IQ signal generator (IQ gen) 310 and output a plurality of pairs of first output signals (OUT1+, OUT1−) in response to a pair of I control signals (CTRL_I+, CTRL_I−) generated in the I control decorder 321.

Also, the plurality of Q control leakage cancellation amplifiers LCA_Q receive a pair of Q differential signals (Q+, Q−) from the IQ signal generator (IQ gen) 310 and output a plurality of pairs of second output signals (OUT2+, OUT2−) in response to a pair of Q control signals (CTRL_Q+, CTRL_Q−) generated in the Q control decorder 323.

Here, the pair of I differential signals (I+, I−) have respective phases of 0° and 180°, and the pair of Q differential signals (Q+, Q−) have respective phases of 90° and 270°.

The I control decoder 321 receives and decodes the I control signal LC_CTRL_I having a plurality of bits from the leakage cancellation controller 600 and outputs the plurality of pairs of I control signals CTRL_I+ and CTRL_I−.

The Q control decoder 323 receives and decodes the Q control signal LC_CTRL_Q having a plurality of bits from the leakage cancellation controller 600 and outputs the plurality of pairs of Q control signals CTRL_Q+ and CTRL_Q−.

The balance to unbalance transformer 325 receives a plurality of pairs of first output signals OUT1+ and OUT1− from the plurality of I control leakage canceling amplifiers LCA_I and receives a plurality of pairs of second output signals OUT2+ and OUT2− from a plurality of Q control leakage canceling amplifiers LCA_Q to match the received signals and output one output signal OUT.

The one output signal OUT is output to the outside through the output terminal LCAOUT of the RF/Analog transceiving unit 1000.

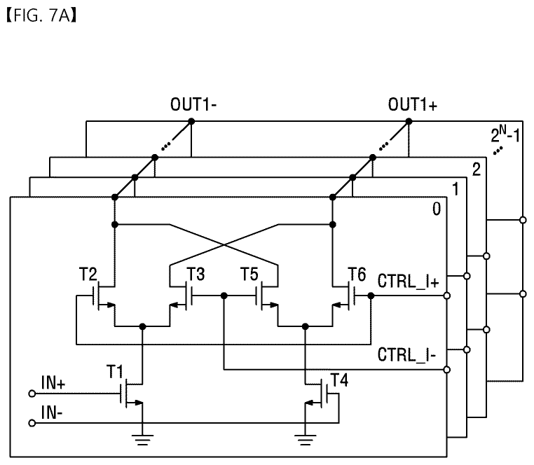

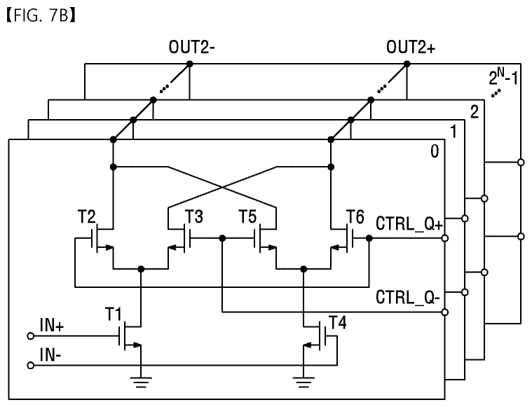

FIG. 7A is an internal circuit diagram of the I path leakage cancellation amplifier LCA_I in the dual leakage cancellation amplifier 320 illustrated in FIG. 6, including first to sixth NMOS transistors T1 to T6.

FIG. 7B is an internal circuit diagram of the Q path leakage cancellation amplifier LCA_Q in the dual leakage cancellation amplifier 320 illustrated in FIG. 6, including first to sixth NMOS transistors T1 to T6.

Since the two amplifiers in FIGS. 7A and 7B have the same internal circuit configuration, a configuration of the I path leakage cancellation amplifier circuit in FIG. 7A will be described below, and this will be applied to the Q path leakage cancellation amplifier LCA_Q.

When an IQ control bit is an N bit, the I path leakage cancellation amplifier includes 2N amplifiers (1st to 2N amplifiers) and operates linearly according to the IQ control bit.

Each of the first to 2N amplifiers, which is in the form of a differential mode differential amplifier, includes an input unit including first and fourth transistors T1 and T4 and an amplification unit including second and third transistors T2 and T3, and fifth and sixth transistors T5 and T6.

Although each of the first to sixth transistors T1 to T6 is an NMOS as an example in this embodiment, other transistors such as a PMOS transistor may be used.

A mutual connection relationship between input and output signals of the first to sixth transistors T1 to T6 is as follows.

Differential input voltages IN+ and IN− are applied to the gate terminals of each of the first transistor T1 and the fourth transistor T4, respectively, and the differential voltages are amplified and output to first and second nodes N1 and N2, respectively.

Here, as the voltage output to each of the first and second nodes N1 and N2, when the differential input voltage IN+ and IN− is greater than a threshold voltage VTH of each of the first and fourth transistors T1 and T4, the first transistor T1 and the fourth transistor T4 are turned on, and a voltage signal obtained by subtracting the threshold voltage VTH from the differential input voltage IN+ and IN− outputs a first amplification signal that is primarily amplified.

On the other hand, the first control signal CTRL_I+ generated in the leakage cancellation controller 600 is applied to a gate terminal of each of the second transistor T2 and the sixth transistor T6, and the second control signal CTRL_I− generated in the leakage cancellation controller 600 is applied to a gate terminal of each of the third transistor T3 and the fifth transistor T5.

Also, a drain terminal of the second transistor T2 is connected to a drain terminal of the fifth transistor T5 and connected to the first output terminal OUT1−, and a drain terminal of the third transistor T3 is connected to a drain terminal of the sixth transistor T6 and connected to the second output terminal OUT1+.

Thus, when the first control signal CTRL_I+ is applied at a high level, the second transistor T2 and the sixth transistor T6 are turned on, the first amplification signal is secondarily amplified at the first and second nodes N1 and N2, and the second amplification signal is output to each of the first output terminal OUT1− and the second output terminal OUT1+.

Also, when the second control signal CTRL_I+ is applied at a high level, the second transistor T3 and the sixth transistor T5 are turned on, the first amplification signal is secondarily amplified at the first and second nodes N1 and N2, and the second amplification signal is output to each of the first output terminal OUT1− and the second output terminal OUT1+.

Next, a time series process by which the leakage signal is canceled will be explained in detail as follows.

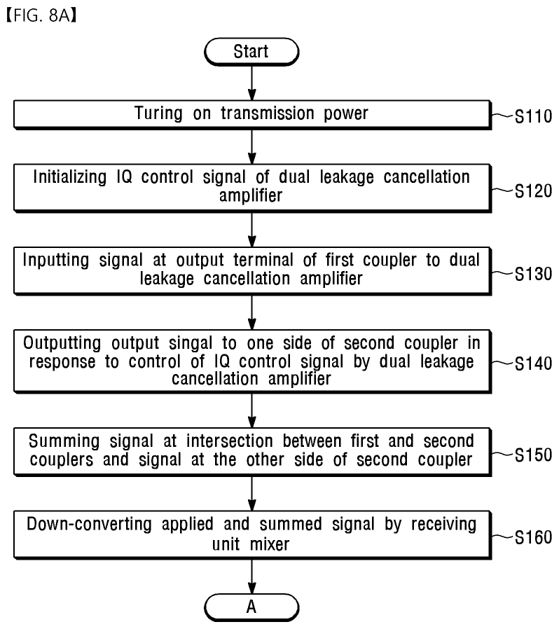

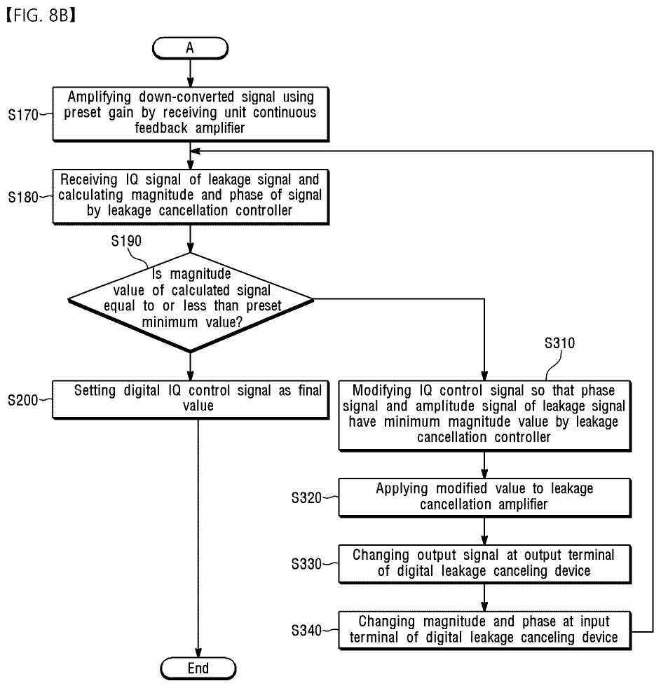

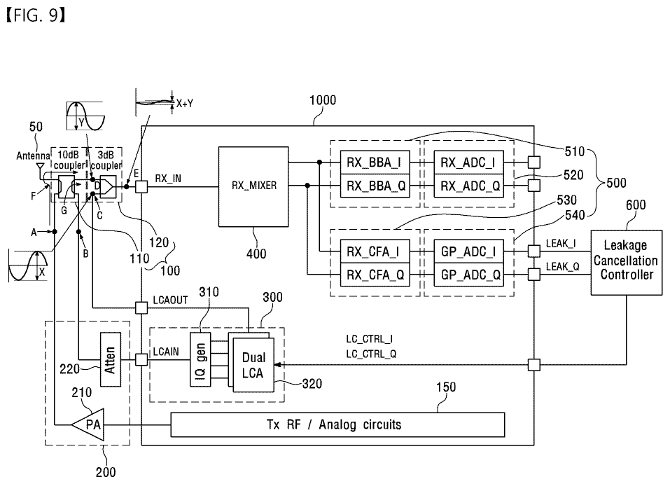

FIGS. 8A and 8B are flowcharts of a method for canceling a leakage signal according to another embodiment of the present invention. FIG. 9 is a view illustrating a waveform at each node as a result of canceling the leakage signal according to the flowchart in FIGS. 8A and 8B.

Hereinafter, a schematic operation of the method for canceling digital leakage of an RFID reader according to another embodiment of the present invention will be described in detail with reference to FIGS. 8A, 8B, and 9.

When transmission power is turned on in a process S110, an IQ control signal of a dual leakage cancellation amplifier 320 is initialized in a process S120.

A signal from an output terminal of a first coupler 110 is input to the dual leakage cancellation amplifier 320 in a process S130.

The dual leakage cancellation amplifier 320 responds to control of an IQ control signal, and an output signal of the dual leakage cancellation amplifier 320 is output to one side of the second coupler 120 in a process S140.

A signal at an intersection D between the first coupler 110 and the second coupler 120 and a signal at the other side of the second coupler 120 are summed in a process S150 and applied to an input terminal of the RF/Analog transceiving unit 1000 in a process S100.

The receiving unit mixer 400 down-converts the summed signal applied to the RF/Analog transceiving unit 1000 in a process S160, and the receiving unit continuous feedback amplifier 530 amplifies the signal down-converted in the receiving unit mixer 400 by a preset gain in a process S170.

The leakage cancellation controller 600 receives a digitally converted I signal and a digitally converted Q signal LEAK_I and LEAK_Q of the leakage signal and calculates a magnitude and a phase of the signal in a process S180.

The leakage cancellation controller 600 compares a calculated magnitude value of the signal with a preset minimum value in a process S190.

When the magnitude value of the signal calculated by the leakage cancellation controller 600 is equal to or less than the preset minimum value, the I control signal LC_CTRL_I and Q control signal LC_CTRL_Q are set to final values in a process S200, and when the magnitude value of the signal is greater than the preset minimum value, the leakage cancellation controller 600 modifies the IQ control signal so that the magnitude values of the digitally converted I signal and the digitally converted Q signal LEAK_I and LEAK_Q of the leakage signal are minimized in a process S310.

When the value modified by the leakage cancellation controller 600 is applied to the dual leakage cancellation amplifier 320 in a process S320, an output signal at the output terminal LCAOUT of the leakage cancellation amplifier 300 is changed in a process S330, and a magnitude and a phase of a signal at the input terminal LCAIN of the leakage cancellation amplifier 300 are changed in a process S340.

The process S180 to the process S340 are repeated until the magnitude value of the signal changed in the RF/Analog transceiving unit 1000 is equal to or less than the preset minimum value.

Hereinafter, a detailed operation of the method for canceling digital leakage of an RFID reader according to another embodiment of the present invention will be described with reference to FIGS. 8A, 8B, and 9.

When the transmission power is turned on, the IQ control signals LC_CTRL_I and LC_CTRL_Q of the dual leakage cancellation amplifier 320 are initialized to “0”.

When a signal of the node B that is an output terminal of a first coupler 110, i.e., the 10 dB coupler, is input to the dual leakage cancellation amplifier 320 through an attenuator 220 and an IQ signal generator 310, the dual leakage cancellation amplifier 320 allows an output of the dual leakage cancellation amplifier 320 to be output to a node C that is one side of a second coupler 120, i.e., 3 dB coupler, in response to control of the IQ control signal.

A signal at the node D that is the other side of the 3 dB coupler 120 and an intersection with the 10 dB coupler 110 and a signal at the C node that is one side of the 3 dB coupler 120 are summed by the 3 dB coupler 120 and applied to an input terminal RX_IN of the RF/Analog transceiving unit 1000. This signal is down-converted by the receiving unit mixer 400, amplified by a predetermined gain (CFA gain) of the receiving unit continuous feedback amplifier 530, and applied to the leakage cancellation controller 600.

The leakage cancellation controller 600 receives the digitally converted I signal and the digitally converted Q signal LEAK_I and LEAK_Q of the input leakage signal and calculates the magnitude and phase of the signal.

The leakage cancellation controller 600 compares the calculated magnitude value with a preset minimum value (min. value), and the magnitude value is equal to or less than the preset minimum value, IQ control bits LC_CTRL_I and LC_CTRL_Q are set to final values, and the process of canceling the leakage signal is finished.

When the calculated magnitude values of the digitally converted I signal and the digitally converted Q signal LEAK_I and LEAK_Q of the leakage signal are greater the preset minimum value, the leakage cancellation controller 600 modifies the IQ control signal of the dual leakage cancellation amplifier 320 so that the digitally converted I signal and the digitally converted Q signal of the leakage signal have minimum magnitude values.

When the modified value is applied to the dual leakage cancellation amplifier 320, the output signal at the output terminal LCAOUT of the RF/Analog transceiving unit 1000 is changed, and accordingly, the magnitude and phase of the signal at a receiving input node E, i.e., the input terminal LCAIN of the RF/Analog transceiving unit 1000, is changed.

The leakage cancellation controller 600 calculates the magnitude and the phase again according to the changed digital IQ signals LEAK_I and LEAK_Q and determines again whether the magnitude is equal to or less than the preset minimum value. The above-described process is repeated until the magnitude is equal to or less than the preset minimum value.

The output at the node D is output by summing a signal G transmitted by an isolation characteristic of the 10 dB coupler 110 and a signal F reflected by a reflection coefficient S11 of the antenna 50.

This signal has the same frequency as the output of the power amplifier (PA) 210, and a magnitude and a phase of the signal are changed by the 10 dB coupler 110 and the antenna 50 (signal magnitude: Y). The leakage cancellation output terminal LCAOUT has the same frequency as the output of the power amplifier (PA) 210 according to values of the leakage cancellation input terminal LCAIN and the leakage cancellation control signals LC_CTRL_I and LCCTRL_Q, and a value in which a magnitude and a phase are adjusted is output (signal magnitude: X).

Thus, a sum of the signal magnitude Y and the signal magnitude X is output from the node E.

Also, when the signal magnitude X of the node C and the signal magnitude Y of the node D are equal to each other, and phases thereof are opposite to each other, as the signal of the node C and the signal of node D are canceled by each other, a signal at the node E is output as in FIG. 9.

Thus, when the output of the D node is referred to as a transmission leakage (Tx leakage) signal, a signal having the same magnitude as and an opposite phase from that of the node D may be produced from the node C to cancel the transmission leakage (Tx leakage) applied to the node E.

As described above, the present invention provides the digital leakage canceling device of the RFID reader capable of increasing an RFID recognition distance by quickly and effectively removing the self-jamming using the digital leakage cancellation unit in the RFID reader in the UHF frequency band and a method thereof.

Through this, the present invention may directly generate a phase-amplitude code for producing the transmission leakage removal signal through the digital process to perform the control in the linear continuous feedback method, thereby extremely quickly removing the transmission leakage.

Also, additional power consumption that may occur in the summing circuit or heat generation caused by the additional power consumption may be prevented in advance by performing the summing between the leakage signal and the leakage removal signal using the coupler.

Also, the number of tags that are readable per unit time under an environment of a single tag or a plurality of tags may increase by decreasing the leakage canceling time of the transmission signal.

Also, the cover range and resolution of the transmission leakage cancellation may be significantly improved by separately processing the two components of the leakage signal.

The method for canceling the digital leakage of the RFID reader according to the present invention may be realized in the form of program commands that are executable through various computer units and recorded on a computer readable medium. The computer readable media may include one of or a combination of a program command, a data file, and a data structure. The program command recorded in the medium is specifically designed and configured for the present invention or well-known technology to a person skilled in the field of computer software. For example, the computer readable media may include: magnetic media such as a hard disk, a floppy disk, and a magnetic tape; optical media such as CD-ROM and DVD; magneto-optical media such as a floptical disk; and a hardware device particularly configured to store and execute a program command, e.g., ROM, RAM, and a flash memory. For example, the program command includes a machine language code produced by a compiler and a high-level language code that is executable by using an interpreter or the like. The hardware device may be configured to operate as at least one software module for performing operations of the embodiment, and the opposite will be true.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### DESCRIPTION OF THE REFERENCE NUMERALS

100: Coupling unit
110: First coupler
120: Second coupler
150: RF/Analog transmission signal processing unit
200: Attenuation and amplification unit
210: Power amplifier
220: Attenuator
300: Leakage cancellation amplification unit
310: IQ signal generator
320: Dual leakage cancellation amplifier
400: Receiving unit mixer
500: Digital signal generation unit
510: baseband analog unit
520: Receiving unit AD converter
530: Receiving unit continuous feedback amplifier
540: General-purpose ADC
600: Leakage cancellation controller
1000: RF/Analog transceiving unit

What is claimed is:

1. A digital leakage canceling device of an RFID reader, comprising:
a coupling unit configured to couple an antenna signal and a power amplifier signal;
an RF/Analog transceiving unit configured to convert a transmission leakage signal generated in the coupling unit into a baseband IQ signal and generate a transmission leakage removal signal as an IQ code to cancel a transmission leakage;
a leakage cancellation controller configured to receive the converted baseband IQ signal, calculate a magnitude and a phase of the signal, and output a leakage cancellation control signal; and
an attenuation and amplification unit configured to attenuate a magnitude of the coupled signal, amplify an RF transmission signal output from the RF/Analog transceiving unit using a built-in power amplifier, and transmit the amplified signal to the coupling unit,
wherein the transmission leakage signal and the transmission leakage removal signal are summed and canceled in the coupling unit.

2. The digital leakage canceling device of claim 1, wherein the coupling unit comprises:
a first coupler having one side connected to the antenna and the other side connected to an output terminal of the attenuation and amplification unit to perform a first coupling with a signal of an input terminal of the attenuation and amplification unit; and
a second coupler having one side connected to an intersection with the first coupler and the other side connected to an output terminal of the RF/Analog transceiving unit to perform a second coupling, thereby outputting a sum of both signals.

3. The digital leakage canceling device of claim 2, wherein the RF/Analog transceiving unit comprises:
a receiving unit mixer configured to receive an RF signal from a node that is second-coupled and multiply the received signal by a local oscillator signal to down-convert the multiplied signal into a baseband signal;
a digital signal generation unit configured to receive the down-converted baseband signal through first and second paths and convert the received signal into a digital signal;
a leakage cancellation amplification unit configured to receive the attenuated coupling signal and adjust a phase and an amplitude of the received signal in response to the leakage cancellation control signal to output the adjusted signal to an output terminal of the RF/Analog transceiving unit; and
an RF analog signal processing unit configured to restore a response signal received from an RFID tag to the antenna.

4. The digital leakage canceling device of claim 3, wherein the digital signal generation unit comprises:
a receiving unit baseband analog unit configured to receive the down-converted baseband signal through the first and second paths to amplify the received signal to a predetermined magnitude or remove components except for the signal;
a receiving unit AD converter configured to receive the baseband signal which is amplified or from which components except for the signal is removed through the first and second paths and convert the received signal into a digital signal;
a receiving unit continuous feedback amplifier configured to receive the down-converted baseband signal through the first and second paths to frequency-down-convert a transmitting unit leakage signal and amplify an analog signal; and
a general-purpose ADC configured to receive the amplified analog signal and convert the received signal into a digital signal, thereby outputting an IQ signal (LEAK_I and LEAK_Q) of the leakage signal.

5. The digital leakage canceling device of claim 3, wherein the attenuation and amplification unit comprises:
an attenuator configured to receive the signal coupled in the first coupler and attenuate a magnitude of the signal to be fit into an input range of the leakage cancellation amplification unit 300, thereby transmitting the attenuated signal to an input terminal (LCAIN) of the RF/Analog transceiving unit; and
a power amplifier configured to receive the restored response signal from the RF analog signal processing unit and amplify power thereof to outputs the amplified signal to the other end of the first coupler.

6. The digital leakage canceling device of claim 5, wherein the leakage cancellation amplification unit comprises:
an IQ signal generator configured to receive the attenuated signal from the attenuator and convert the received signal into a pair of I differential signals (I+ and I−) and a pair of Q differential signals (Q+ and Q−) to output the converted signals; and
a dual leakage cancellation amplifier configured to receive the pair of converted I differential signals (I+ and I−) and the pair of converted Q differential signals (Q+ and Q−) and adjust phases and an amplitudes of the received signal in response to an I control signal (LC_CTRL_I) and a Q control signal (LC_CTRL_Q) to output the adjusted signals to the second coupler.

7. The digital leakage canceling device of claim 6, wherein a signal at an output node (C) of the dual leakage cancellation amplifier is coupled with a signal at a node (D), which is obtained as an input signal is self-jammed in the first coupler, in the second coupler and applied to a receiving input node of the RF/Analog transceiving unit.

8. The digital leakage canceling device of claim 7, wherein the dual leakage cancellation amplifier generates a signal having a magnitude and a phase sufficient to remove transmission leakage at the node (D) and supplies the signal to the node (C) that is the other side of the second coupler.

9. The digital leakage canceling device of claim 6, wherein the dual leakage cancellation amplifier comprises:
a plurality of I control leakage cancellation amplifiers (LCA_I) configured to receive a pair of I differential signals (I+ and I−) from the IQ signal generator and output a plurality of pairs of first output signals (OUT1+ and OUT1−) in response to a plurality of pairs of I control signals (CTRL_I+ and CTRL_I−);
a plurality of Q control leakage cancellation amplifiers (LCA_Q) configured to receive a pair of Q differential signals (Q+ and Q−) from the IQ signal generator and output a plurality of pairs of second output signals (OUT2+ and OUT2−) in response to a plurality of pairs of Q control signals (CTRL_Q+ and CTRL_Q−);
an I control decoder configured to receive and decode an I control signal having a plurality of bits from the leakage cancellation controller to output the plurality of pairs of I control signals (CTRL_I+ and CTRL_I−);
a Q control decoder configured to receive and decode a Q control signal having a plurality of bits from the leakage cancellation controller to output the plurality of pairs of Q control signals (CTRL_Q+ and CTRL_Q−); and
a balance to unbalance transformer configured to receive a plurality of pairs of first output signals (OUT1+ and OUT1−) and a plurality of pairs of second output signals (OUT2+ and OUT2−) to match the received signals and output one output signal (OUT).

10. A digital leakage canceling method of an RFID reader, comprising:
(a) initializing an IQ control signal of a leakage cancellation amplifier when transmission power is turned on;
(b) receiving a digital IQ signal (LEAK_I and LEAK_Q) and calculating a magnitude and a phase of the signal by a leakage cancellation controller;
(c) comparing a magnitude value of the calculated signal with a preset minimum value by the leakage cancellation controller;
(d) setting an I control signal (LC_CTRL_I) and a Q control signal (LC_CTRL_Q) as final values when the magnitude value of the calculated signal is equal to or less than the preset minimum value;
(e) modifying the IQ control signal by the leakage cancellation controller so that the digital IQ signal (LEAK_I and LEAK_Q) of the leakage signal has a minimum magnitude value when the magnitude value of the calculated signal is greater than the preset minimum value;
(f) changing an output signal at an output terminal (LCAOUT) of the RF/Analog transceiving unit and a magnitude and a phase of a signal at an input terminal (LCAIN) of the RF/Analog transceiving unit when the modified value is applied to the leakage cancellation amplifier; and
(g) repeating the processes (b) to (f) until a magnitude value of the changed signal is equal to or less than the preset minimum value.

11. The digital leakage canceling method of claim 10, further comprises, between the processes (a) and (b):
inputting a signal at an output terminal of a first coupler to the leakage cancellation amplifier;
outputting an output signal of the leakage cancellation amplifier to one side of a second coupler in response to control of the IQ control signal by the leakage cancellation amplifier;
applying a signal obtained by summing a signal at an intersection between the first coupler and the second coupler and a signal at the other side of the second coupler to an input terminal (RX_IN) of the RF/Analog transceiving unit; and
down-converting the applied and summed signal by a receiving unit mixer and amplifying the down-converted signal using a preset gain by a receiving unit continuous feedback amplifier.

12. The digital leakage canceling method of claim 11, wherein a signal (G) transmitted by an isolation characteristic of the first coupler and a signal (F) reflected by a reflection coefficient (S11) of an antenna are summed and output at the intersection between the first coupler and the second coupler.

13. A computer-readable recording medium of a digital leakage cancellation method of an RFID reader, in which a program for performing the method of claim 10 on a computer is recorded.

14. A computer-readable recording medium of a digital leakage cancellation method of an RFID reader, in which a program for performing the method of claim 11 on a computer is recorded.

15. A computer-readable recording medium of a digital leakage cancellation method of an RFID reader, in which a program for performing the method of claim 12 on a computer is recorded.
